(19) United States
(12) Patent Application Publication
(10) Pub. No.: US 2010/0262837 A1
(43) Pub. Date: Oct. 14, 2010

(54) Systems And Methods For Personal Digital Data Ownership And Vaulting

(76) Inventor: Haluk Kulin, New York, NY (US)

Correspondence Address: PATENT GROUP 2N;JONES DAY, NORTH POINT, 901 LAKESIDE AVENUE, CLEVELAND, OH, 44114, US

(21) Appl. No.: 12/759,253

(22) Filed: Apr. 13, 2010

Related U.S. Application Data
(60) Provisional application No. 61/168,937, filed on Apr. 14, 2009.

(51) Int. Cl. G06F 12/14

(52) U.S. Cl. 713/189

(57) ABSTRACT

Systems and methods are provided for aggregating user-generated digital information. As an example, a system and method can be configured to collect, throughout a current day, a plurality of digital data receipts from different classes of information representing the user activities of a single user; encrypt each data receipt using an encryption method under the control of the user; rout each encrypted data receipt to a first storage facility; and aggregate the encrypted data receipts associated with the user at a second storage facility.

### CROSS REFERENCE TO RELATED APPLICATION

This application claims priority to U.S. Provisional Application No. 61/168,937 entitled “Personal Digital Data Ownership And Vaulting,” which was filed on Apr. 14, 2009, and is incorporated into the present application by reference in its entirety as if fully rewritten herein.

### TECHNICAL FIELD

This document relates generally to systems and methods for data acquisition and more particularly to systems and methods for enabling a user to collect, aggregate and control the use of digital information pertaining to that user.

### BACKGROUND AND SUMMARY

Individuals create digital data every time they interact with a digital device. Most people now have access to a payment card, a mobile phone, a laptop or desktop computer and/or other types of digital devices. The data generated on or by these devices ranges from created documents such as word processing documents or spreadsheets, payment information such as that found on payment receipts, information regarding content viewed such as on television or via the Internet, and geo location data.

Systems for collecting bits and pieces of an individual's digital footprint have been used for many years in a diverse number of areas. Typically this data is stored by different third-party companies on their databases. Increasingly, this data is being used to drive analysis into consumer behavior and contextual digital advertising.

Current approaches, however, have difficulty in providing an automated or semi-automated mechanism for empowering a particular user to aggregate digital information pertaining to that user that has been generated at disparate and unrelated sources or to provide a mechanism for a user to control how much, if any, of this digital information can be accessed and used by third parties. As an illustration, current approaches do not allow an individual to aggregate different aspects of his or her digital footprint such as his or her purchase history from a number of distinct retailers, Internet browsing history, and television viewing history; protect and control access to this aggregated information; and allow controlled and anonymous access by third parties who in exchange for the right of access to this information confer a tangible benefit on the individual.

In accordance with the teachings provided herein, systems and methods for allowing an individual user to aggregate and control access to aspects of his or her digital footprint are provided in a data acquisition system. As an example, a system and method can be configured for allowing an individual user to collect various aspects of his digital footprint on assets owned by the user, to store this aggregated digital information in a secure manner, and to offer controlled access to portions of this aggregated digital information to third parties.

### BRIEF DESCRIPTION OF THE FIGURES

FIG. 1 is a block diagram depicting a data acquisition system for collecting and allowing controlled access to user-generated digital information.

FIG. 2 is a block diagram depicting an operational scenario utilizing a system for collecting and allowing controlled access to user-generated digital information.

FIG. 3 is a state diagram depicting an operational scenario for a data acquisition system for collecting and allowing controlled access to user-generated digital information.

FIG. 4 is a state diagram depicting an operational scenario for a data acquisition system for collecting and allowing controlled access to user-generated digital information.

### DETAILED DESCRIPTION

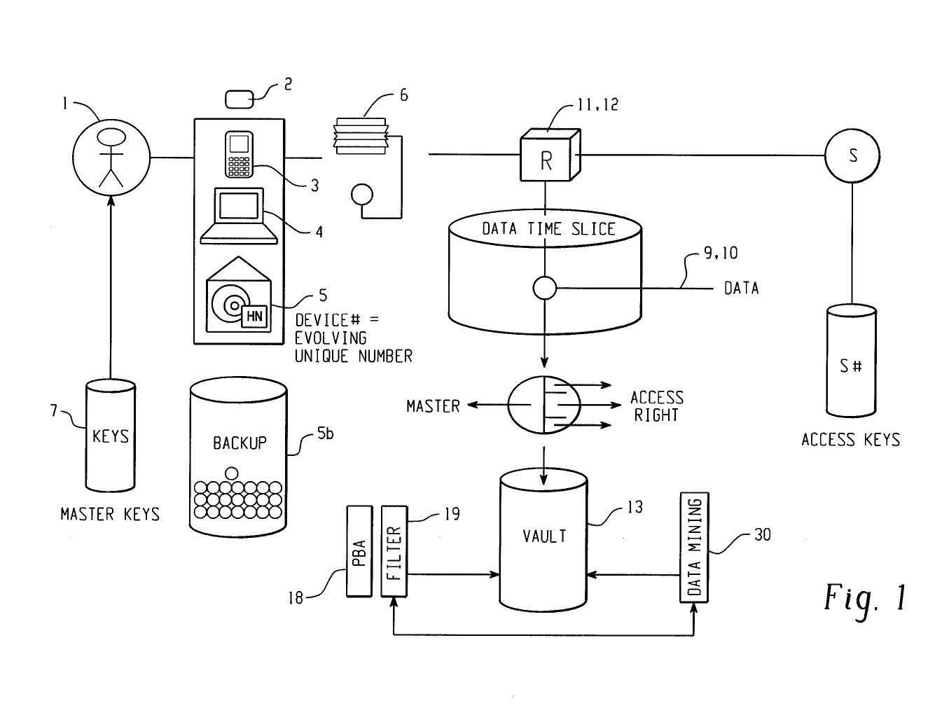

FIG. 1 depicts a data acquisition system for allowing an individual user 1 to aggregate and control access to aspects of his or her digital footprint. As shown in FIG. 1, a user 1 may have access to various portable digital devices such as a payment card 2 (e.g., a credit card, gift card, etc.), a mobile handheld communication device 3 (e.g., a smart phone, personal digital assistant, etc.), and a laptop computer 4, and other digital devices within a home network 5. The home network 5 could comprise a wired or wireless network or combination thereof and include a desktop computer 5a; access to a digital storage device 5b which may comprise a physical storage device at the user's premises (e.g., a hard drive, flash storage device, etc.) and/or access to a virtual storage device accessible via the Internet; and an Internet access device 5c (e.g., a cable modem, a dsl modem, wireless router, etc.).

A software application 6 is shown that can be installed on the handheld 3, laptop 4, and/or desktop 5a. As illustrated, the software application 6 facilitates the collection of digital information generated as a result of a user's use of his digital devices by providing for the generation of digital data receipts that can be captured, secured, and stored by the system. Also, the software application 6 can facilitate the establishment of a public key infrastructure (“PKI”) for securing the digital data receipts. As an example, software application 6 may generate private keys 7 that remain in the control of the user and generate public keys 8 that are stored with the data receipts.

There are multiple classes of user activity that can be captured by the system. For example, the system can capture purchase information such as information found on purchase receipts, attention information such as browsing history or television viewing history, claim data such as a status update information provided by a user on a social networking internet site, location information such as GPS position information provided by a user's GPS device from a user's mobile phone, personal information such as a user's social security number or credit card number, medical information, education information, financial information, and other classes of digital information. Preferably each digital receipt includes a time stamp for associating the digital information with the time at which the user activity represented by the digital data took place.

A router 11, 12 is shown, which routes data 9 to a storage vault 13 for storing data for multiple users. The router can capture and route the data in real-time or near real-time (e.g., throughout the day) when the digital information is being generated or alternatively at a later time when cued by the user to capture the data.

By evaluating a user's digital footprint 16 from various sources for various relationships a personal algorithm (“PBA”) 18 for a user can be created. The personal algorithm 18 is combined with a filter 19 that controls access by a third party to the user's digital data in vault 13. Each user 1 can identify to filter 19 through application software 6 the type of access to their personal data they are willing to grant and the terms under which that access will be granted via for example a Personal Digital Rights Management System (“PDRM”). Third parties can engage in data mining 30 and access information in vault 13 based on access granted by filter 19.

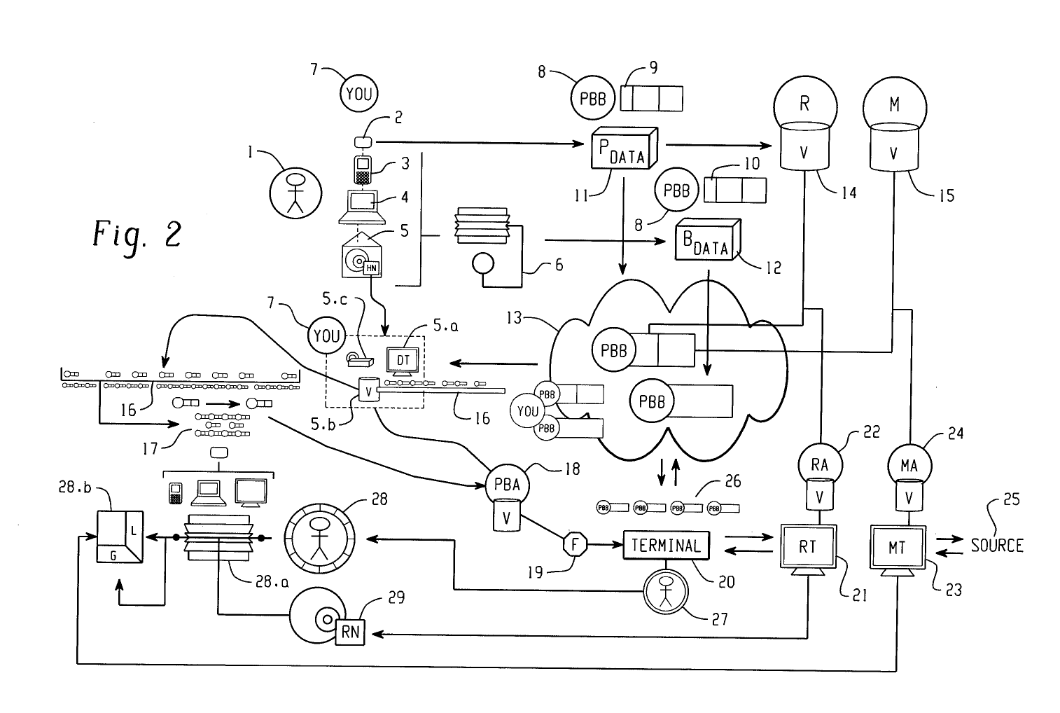

FIG. 2 illustrates an exemplary use of the system. A user 1 who has access to the system may have application software 6 installed on various digital devices such as devices 3, 4, and 5a. Digital information is generated as a result of user activity resulting in data receipts 9 and 10. In this example, data receipt 9 is a purchase transaction receipt with a retailer detail component and a manufacturer detail component. This includes the who, what, and where details of the purchase. Data receipt 10 in this example captures behavioral digital information such as a time slice of Internet browsing history, television or other content viewing history, geo-location information, and/or other information regarding the user's behavior. In response to creation of data receipts 9 and 10, the software application 6 creates a private key 7 that resides in the ownership of the individual and creates a public key 8 that is stored in the identity field of the data receipts 9 and 10.

A router is provided to capture and send the data receipts to secure cloud storage 13 provided by a service provider. In this example, a purchase data router 11 is provided to send purchase data from the purchase data receipt 9 to the secure cloud storage 13 and a behavioral data router 12 is provided to send behavioral data from the behavioral content data receipt 10 to the cloud storage 13. As an example, the purchase data router 11 could be provided by application 6 which may provide a means for transferring an image of a physical paper receipt scanned using a handheld device to the secure cloud storage 13. Application 6 could also provide a behavioral data router which, for example, could access a user's Internet browsing history or handheld's geo-location information and periodically send time-slices of that information to the cloud storage 13.

At the cloud, each receipt 9, 10 is analyzed for usage rights. The user 1 through the application 6 can designate which class of its data receipts (or content from its data receipts) can be shared with third parties. Based on the user's usage right designations, certain information from the data receipts can be shared with real or virtual storage facilities for retailers 14 and/or real or virtual storage facilities for manufacturers 15 and security keys associated with that information issued.

The user's application software 6 initiates a backup process that matches the private keys 7 to the data 9 and 10 in the cloud storage 13 and causes the data 9 and 10 for a particular user to get aggregated at the user's personal vault 5.b. Over time, a user's digital footprint 16 from various sources is accumulated, can be analyzed for various relationships 17, and a personal algorithm 18 created based on the various relationships.

The personal algorithm 18 gets incorporated into a personal dashboard filter 19, which communicates with a Query and Media (“Q&M”) terminal 20. This terminal 20 allows third parties, such as retailers and manufacturers, controlled access to user data stored in the cloud storage 13.

Third-party retailers and manufacturers have access to data terminals, which may be real or virtual, for communicating with Q&M terminal 20. Retailer data terminals 21 executes a retailer algorithm 22 that is the aggregation of the retailers data vault 14 and manufacturer terminal 23 executes a manufacturer algorithm 24 that is the aggregation of the manufacturer data vault 15. In addition to these vaults, the manufacturer may further be connected to an internal database 25 (e.g., Oracle or SAP) system that enables full supply chain information connection. Through the supplier terminals 21 and 23, via Q&M terminal 20, suppliers (e.g., retailers and manufacturers) can query the users 1.

Based on a user's response via its previously established Personal Digital Rights Management system implemented through filter 19, suppliers may view data 26 on terminals 21 and 23. This data does not identify the user and cannot be drawn out of the system.

The suppliers may also send a response through the Q&M terminal 20 to the media application 27. Based on the user's PDRM settings in filter, suppliers may place contextual advertising on a user's personal digital media assets 28 via media application 27. The personal digital media assets 28 are embedded on a user's personal devices 3, 4 and 5 through the software application 6 to create personal media spaces 28.a that connect to specific data utilities such as the purchase engine 28.b. These assets 28 can receive direct content from the supplier terminals 21 and 23 as well as local retail broadcast 29 that run proximity based edge advertising.

Each user can add new digital devices through its Home Network 5 to extend the source of digital data. Each user's response to the query and media requests and ensuing interactions are fed back in the system and get added to the various system algorithms.

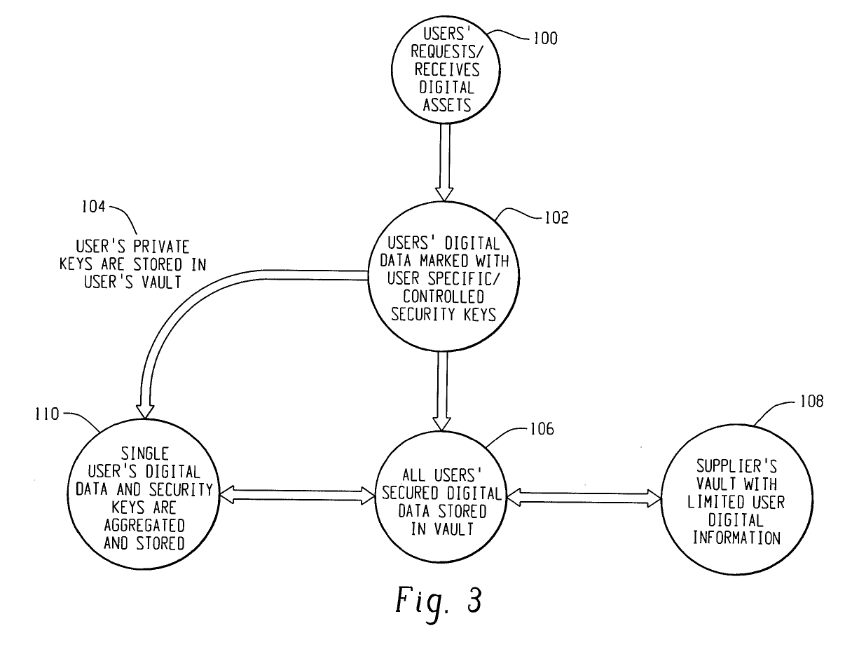

FIG. 3 depicts a state diagram illustrating an exemplary use of the system. At state 100, a user 1 requests digital assets and receives a digital application 6 that it uploads to the user's personal devices 3, 4, and 5. The user can also obtain devices with the application 6 pre-loaded. The user can also obtain a purchase card 2 for use with the system. After the application 6 is loaded, at state 102 the individual devices issue private and public keys that mark a user's data with an ownership seal that is managed by the Personal Digital Rights Management tool in Filter 19. All data that is originated by the individual (e.g., purchase, content request, etc.) creates a private key 7 that resides under the user's control, establishes ownership of the data, and synchronizes the data with the rest of the system. At step 104, the private keys are aggregated at the user's data vault 5.b. Periodically, a process is instigated that matches the Private and Public keys. If the public key data is missing, the system issues a request to the supplier for a copy of the digital receipt. The system also allows paper receipts to be scanned and fed into the system through a purchase data router 11. At state 106, data from multiple users are stored in a secure cloud 13. At state 108, each data pack is then processed for digital rights management, where the relevant data parts of each receipt are shared with their provider 14 and 15. The providers receive data receipts that lack the identification of the user or access to the part of the receipt regarding their products. Once data sets for each user have been matched using the public and private keys, the data is aggregated by the user (state 110).

An algorithm 18 is created based on purchase behavior and other data such as content, traffic (e.g., location as detailed by geo location tracking), personal network (e.g., individuals with whom a user has interacted through communication and traffic correlation), medical, and other relevant data sources. The algorithm 18 is then embedded into the filter 19 via the Application 6 to drive Query and Media based marketing through a Q&A Terminal 20. The Q&A terminal allows suppliers to view data based on requests made through a supplier terminal 21/23 that can be driven through a web (virtual) or through a specific workstation. The Q&A Terminal 20 allows data to be viewed, but not withdrawn from the cloud. Companies can engage in a direct dialogue with users in an anonymous manner and offer media content. The Q&A terminal 20 can also run a bidding system that allows the users to maximize their profit.

Users can through this system create a controlled data relationship with the world where their privacy and access to data is controlled by them for their profit and benefit. The system allows multiple utilities to be created to benefit from this data, such as a purchase engine. The purchase engine 28.b is part of the software application 6 and can run on browsers or as a stand-alone software application. The system enables users to keep track of their purchases and measure their carbon footprint, waste footprint and positive marketing impact through their share of purchases both in aggregate as well as in real time through edge marketing 29. In edge marketing, a retailer can broadcast directly to users and offer personalized marketing. In addition, individuals can create family or friendship networks to bring greater value to their data.

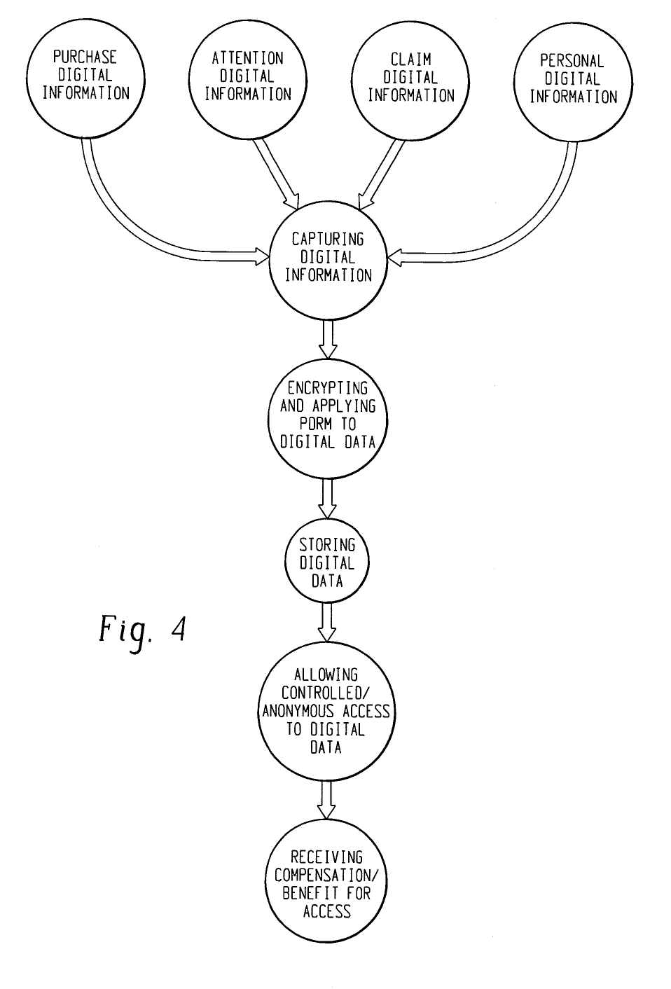

FIG. 4 is a state diagram depicting an operational scenario for a data acquisition system for collecting and allowing controlled access to user-generated digital information.

The methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. For example, a computer can be programmed with instructions to perform the various steps of the operations shown in the figures.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A processor-implemented method for collecting and providing user-controlled access to user-generated digital information, said method comprising:
collecting, throughout a current day, a plurality of digital data receipts from different classes of information representing the user activities of a single user;
encrypting each data receipt using an encryption method under the control of the user;
routing each encrypted data receipt to a first storage facility;
aggregating the encrypted data receipts associated with the user at a second storage facility; and
providing user controlled access to a third party to at least a portion of the data from the aggregated data receipts;
said portion of the data from the aggregated data receipts being generated by:
generating a personal algorithm from the aggregated data receipts;
identifying digital rights management criteria for the data; and
filtering the data based on the personal algorithm and the digital rights management criteria; and
said collecting, encrypting, routing, aggregating, generating, identifying and filtering steps being performed by one or more data processors.

2. The method of claim 1, wherein the different classes of information representing the user activities are selected from a group of classes comprising purchase information, attention information, claim data, medical information, education information, financial information and personal data.

3. The method of claim 1, wherein the encrypting step utilizes a public key infrastructure.

4. The method of claim 1, wherein the first storage facility is provided by a service provider via the Internet.

5. The method of claim 1, wherein the encrypting and routing steps are performed in real-time or near real-time.

6. The method of claim 1, wherein the second storage facility is provided by a service provider via the Internet.

7. The method of claim 1, wherein the second storage facility is provided by hardware located within the user's home network.

8. The method of claim 1, wherein the second storage facility is provided as a virtual drive in the user's home network.

9. The method of claim 1 further comprising receiving a user benefit from the third party in exchange for access to the portion of the data.

10. The method of claim 1, wherein the providing user controlled access to a third party step comprises:
providing an online terminal for use by the third party in requesting data; and
providing requested data to the third party based on the user's consent to data access.

11. The method of claim 10, wherein the user provides consent to data access via a personal digital rights management system.

12. A method for collecting and providing user-controlled access to user-generated digital information, said method comprising:
receiving, throughout a current day, a plurality of digital data receipts from different classes of information representing the user activity of multiple users;
uniquely encrypting each data receipt wherein each user has control over the encryption method applied to its data receipts;
storing each encrypted data receipt at a first computer storage location;
aggregating for each user at a unique computer storage location for each user the encrypted data receipts associated with that user;
providing user controlled access to a third party to at least a portion of the data from the aggregated data receipts;
said portion of the data from the aggregated data receipts being generated by:
generating a personal algorithm for each user from the aggregated data receipts;
identifying digital rights management criteria for the data; and
filtering the data based on the personal algorithm and the digital rights management criteria; and
said receiving, encrypting, storing, aggregating, generating, identifying and filtering steps being performed by one or more data processors.

13. The method of claim 12, wherein the different classes of information representing the user activities are selected from a group of classes comprising purchase information, attention information, claim data, medical information, education information, financial information and personal data; and wherein the encrypting and routing steps are performed in real-time or near real-time.

14. The method of claim 13, wherein the second storage facility is provided by hardware located within the user's home network.

15. The method of claim 13, wherein the second storage facility is provided as a virtual drive in the user's home network.

16. The method of claim 12 further comprising receiving a user benefit from the third party in exchange for access to the portion of the data, and wherein the providing user controlled access to a third party step comprises:
providing an online terminal for use by the third party in requesting data; and
providing requested data to the third party based on the user's consent to data access.

17. A data acquisition system for collecting and providing user-controlled access to user-generated digital information, comprising:
a router for executing on one or more data processors and for collecting, throughout a current day, a plurality of digital data receipts from different classes of information representing the user activities of a single user;
an encryption engine executing on the one or more data processors and for encrypting each data receipt using an encryption method under the control of the user;
a first computer storage facility for storing each encrypted data receipt;
a second computer storage facility for aggregating the encrypted data receipts associated with the user; and
a terminal engine executing on the one or more data processors for providing user controlled access to a third party to at least a portion of the data from the aggregated data receipts.

18. The system of claim 17, further comprising:
software code executing on one or more data processors for generating a personal algorithm for each user from the aggregated data receipts, for identifying digital rights management criteria for the data, and for filtering the data based on the personal algorithm and the digital rights management criteria; and
wherein the different classes of information representing the user activities are selected from a group of classes comprising purchase information, attention information, claim data, medical information, education information, financial information and personal data; and
wherein the second storage facility comprises a virtual drive accessible in the user's home network.

19. The system of claim 17, further comprising software code executing on one or more data processors for providing a virtual terminal for use by the third party in requesting data and for providing requested data to the third party based on the user's consent to data access.

20. The system of claim 17, wherein the second storage facility comprises hardware located within the user's home network.
